(19) United States
(12) Patent Application Publication
(10) Pub. No.: US 2009/0123035 A1
(43) Pub. Date: May 14, 2009

(54) Automated Video Presence Detection

(75) Inventors: Joseph F. Khouri, San Jose, CA (US); Laurent F. Philonenko, San Francisco, CA (US); Mukul Jain, San Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/939,289

(22) Filed: Nov. 13, 2007

(51) Int. Cl. G06K 9/00

(52) U.S. Cl. 382/115

(57) ABSTRACT

In an embodiment, a method includes receiving an image of a conference attendee. The method also includes extracting biometric information associated with the conference attendee from the image and determining a status of the conference attendee. The method further includes communicating the status of the conference attendee in response to determining the status of the conference attendee.

### TECHNICAL FIELD

This disclosure relates in general to communication systems.

### BACKGROUND

There are many methods available which allow groups of individuals located throughout the world to engage in conferences. Such methods generally involve transmitting information and other data from communication equipment located at one conference site to communication equipment located at one or more other locations. When engaging in a conference, participants may desire to know whether certain participants at a remote site are present. While teleconferencing may allow participants to see or hear participants at a remote site, it may not indicate when a new conference attendee arrives or when a conference attendee exits. Additionally, if a conference attendee is silent or outside the coverage area of a camera, a participant may not be aware of that an attendee at a remote site is present.

In recent years, many advances have been made in the area of facial recognition. In particular, several programs using various image based and/or video based identity recognition algorithms have been developed. Certain systems, when properly calibrated, are capable of recognizing a person among a large pool of people. Examples of such programs include FaceVACS® by Cognitech and FaceIT® by L-1 Identity solutions.

### BRIEF DESCRIPTION OF THE DRAWINGS

FIG. 1 is a simplified block diagram illustrating a communication system for conducting a teleconference including a facial recognition system;

FIG. 2 is a simplified block diagram illustrating a facial recognition system in accordance with an embodiment; and

FIG. 3 is a flowchart illustrating a method for detecting the presence of a conference attendee according to a particular embodiment.

### DESCRIPTION OF EXAMPLE EMBODIMENTS

OVERVIEW

In an embodiment, a method includes receiving an image of a conference attendee. The method also includes extracting biometric information associated with the conference attendee from the image and determining a status of the conference attendee. The method further includes communicating the status of the conference attendee in response to determining the status of the conference attendee.

In certain embodiments the method may also include determining whether the extracted biometric information matches biometric information associated with a known identification. Additionally, the method may include associating the conference attendee with the known identification and communicating the status of the conference attendee in response to associating the conference attendee with the known identification.

DESCRIPTION

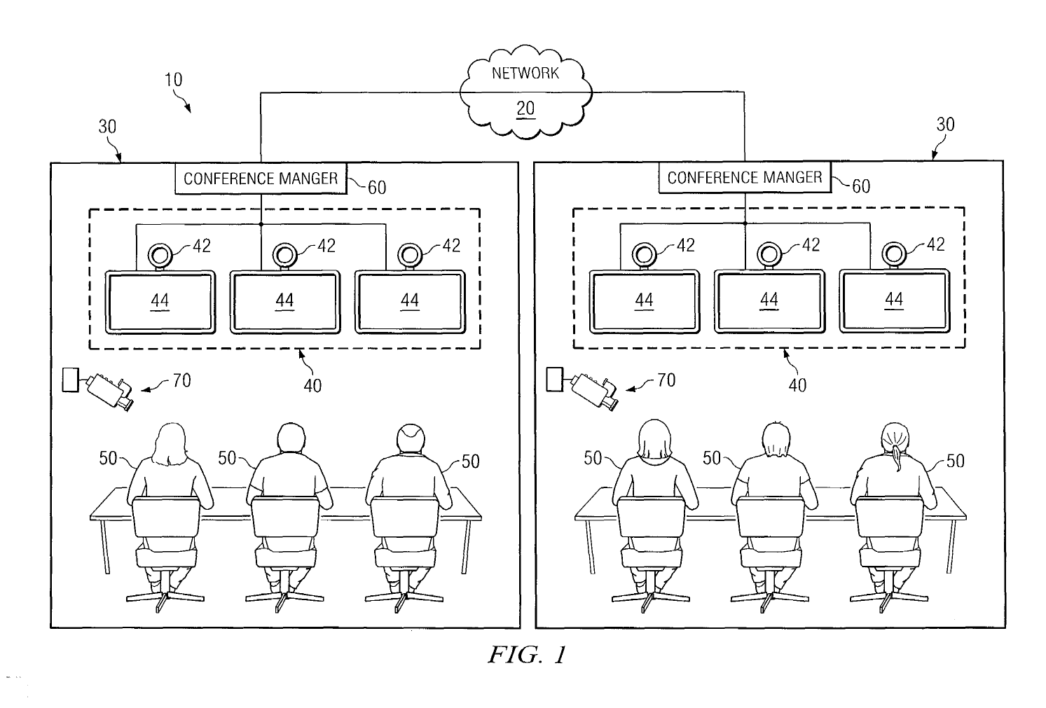

FIG. 1 is a simplified block diagram illustrating a communication system 10 for conducting a teleconference between remote locations. The illustrated embodiment includes a communication network 10 that may support conferencing between remotely located sites 30 using conference equipment 40 and conference manager 60. Also included is facial recognition system 70 which may identify and communicate that a user 50 is present at a conference site 30. As used herein, a “conference” may include any communication session between a plurality of users transmitted using any audio and/or video means, including signals, data or messages transmitted through voice and/or video devices, text chat, and instant messaging.

Communication network 20 represents communication equipment, including hardware and any appropriate controlling logic, for interconnecting elements coupled to network 20 and facilitating communication between sites 30. Communication network 20 may include a local area network (LAN), a metropolitan area network (MAN), a wide area network (WAN), any other public or private network, a local, regional, or global communication network, an enterprise intranet, other suitable wireline or wireless communication link, or any combination of the preceding. To facilitate certain communication capabilities, communication network 20 may include any combination of gateways, routers, hubs, switches, access points, base stations, and any other hardware, software, or a combination of the preceding that may implement any suitable protocol or communication. While the illustrated embodiment indicates that communication system 10 includes a single communication network 20, communication system 10 may include any number or arrangement of communication networks 20.

Sites 30 are endpoints which may engage in a conference. In general, sites 30 may include any suitable combination or collection of hardware and/or software which may facilitate any form of teleconference including videoconferencing and phone conferencing. Sites 30 may be coupled to a communication network, such as communication network 20, and thereby support intra-eneterprise conferencing and/or inter-enterprise conferencing among users 50. In the disclosed embodiment, sites 30 include conference equipment 40, conference manager 60, and facial recognition system 70.

Users 50 represent one or more individuals or groups of individuals who may be present for a conference. Users 50 may participate in a conference using any suitable device and/or component, such as audio Internet Protocol (IP) phones, video phone appliances, personal computer (PC) based video phones, and streaming clients. During a conference, users 50 may engage in the session as speakers or participate as non-speakers. Additionally, in certain embodiments a user 50 may participate in a conference by dial-in or other remote login procedure. Thus, presence at a site 30 is not required for a user 50 to participate in a conference session.

Conference equipment 40 may facilitate videoconferencing or other communications between users 50. Conference equipment 40 may include any suitable elements to establish and facilitate a teleconference. In particular, conference equipment 40 may include any number of microphones, cameras, video cameras, loudspeakers, user interfaces, monitors, computers, telephones, Internet protocol (IP) phones, and/or speakerphones. Conference equipment may also include one or more network interfaces, memories, processors, codecs, or any other suitable hardware or software for engaging in a conference between remote locations. In operation, conference equipment 40 may establish a conference session using any suitable technology and/or protocol, such as Session Initiation Protocol (SIP) or H.323. Additionally, conference equipment 40 may support and be interoperable with video systems supporting other standards, such as H.261, H.263, and/or H.264.

In the illustrated embodiment, conference equipment 40 includes video cameras 42 and monitors 44 which may facilitate videoconferencing. Video cameras 42 may include any suitable hardware and/or software for capturing and transmitting an image of a user 50. In particular, video cameras 42 may capture and generate a video signal which may be transmitted to a remote site 42. Monitors 44 include any suitable hardware and/or software operable to receive a video signal and display the image of a remote user 50 to other users 50. Examples of monitors 44 include a television, video projector, or computer monitor. Monitors 44 may include software and hardware operable to support any suitable video standard such as high definition (HD), moving picture experts group (MPEG), or any encoding/decoding protocol.

Conference manager 60 represents any equipment including hardware and/or software suitable for managing a multipoint conference. Conference manager 60 may include one or more processors, memories, interfaces, or codecs which may compress, decompress, or otherwise process data. In operation, conference manager 60 may serve as an intermediary between conference equipment 40 and communication network 20. In particular, conference manager 60 may transmit and receive signals, packets, cells, or frames containing conference data between sites 30 via network 20. Conference manager 60 may also route conference data to appropriate communication equipment 40. In certain embodiments, conference manager 60 may be further operable to apply any relevant policies to conference sessions. Such policies may be user specific, site specific, or conference specific. In a particular embodiment, conference manager 60 may also include a display or user interface to receive and present suitable information to conference participants.

One or more sites 30 may also include a facial recognition system 70. Facial recognition system 70 may comprise hardware and/or software for determining the identity of a user 50 using image based biometric or other information. Biometric information may be any physical trait or characteristic which is unique to a user 50 such as, for example, facial or retinal patterns. In certain embodiments, facial recognition system 70 may include technology such as FaceVACS® manufactured by Cognitec Systems of Dresden, Germany and/or Facelt® manufactured by L-1 Identity Solutions of Stamford, Conn. To facilitate the described functionality, facial recognition system 70 may include one or more cameras or other devices operable to scan, capture, or otherwise generate a suitable image for identification of a user 50. Facial recognition system 70 may also include software for biometric authentication and identification. The software may employ any suitable identification or recognition algorithm or protocol including ones implementing eigenfaces, a hidden Markov model, and/or dynamic link matching. In an embodiment, the described identification capabilities of facial recognition system 70 may be disaggregated and implemented through various components of conference equipment 40. In particular, video cameras 42 may be operable to capture an image suitable for biometric identification and conference manager 60 may store software and other data for matching the biometric data from the image to an identity.

In operation, facial recognition system 70 may detect the presence of a visible and recognizable user 50 at a local site 30. In particular, facial recognition system 70 may use biometric information associated with a user 50 to identify a user 50 as a current conference participant. The identification may involve generating an image of the user 50 and extracting biometric information associated with the user from the image. The extracted biometric information may be matched and/or compared to biometric information that is associated with a known identity. The matching procedure may employ any suitable protocol or algorithm, including those previously mentioned. If facial recognition system 70 determines that a match exists, the system may associate the user 50 attending the conference with the known identification. Alternatively, if facial recognition system 70 is unable to match the biometric information associated with a user 50 to a known identity, the system may identify the user 50 by a generic name such as “user 1,” “user 2,” etc.

Facial recognition system 70 may also communicate the presence of a local user 50 to conference participants at a remote site 30, whether such users are voice-only participants or voice and video participants. As an example, facial recognition system 70 may generate and maintain a list of conference attendees that are currently present at a local site 30. The list may comprise a plurality of names (real or generic) associated with identified users 50. By interfacing with network 20 and/or a device coupled to network 20, facial recognition system may transmit the list of attendees to a remote site 30. Upon receiving the list, conference equipment 40 at the remote site 30 may inform the local users 50 by displaying an update on a monitor 44. In certain embodiments, conference equipment 40 may inform local users 50 by broadcasting an audio announcement. This may be useful for blind or visually impaired attendees that are unable to watch a remote participant join a conference on a monitor 44. Additionally, the audio announcement may be helpful for voice-only participants that may dial-into a conference remotely. In certain situations, the announcement may even be useful for users 50 that may not be constantly watching monitor 50 and thus may miss activity at a remote conference site.

Facial recognition system 70 may be further operable to identify when a conference participant joins and leaves a conference. Because a user 50 may not be positioned in the line of site of a video camera 42 or may be participating by a voice only or dial-in connection, a remote participant may be unaware that a user 50 has joined or exited a conference. Thus, facial recognition system 70 may update the list of current conference attendees or otherwise indicate that a change in status with respect to a user 50 has occurred whenever a user 50 joins or exits a conference. To facilitate this capability, facial recognition system 70 may be positioned at or near an entry/exit to a site 30. Facial recognition system 70 may also include a sensor or other device to determine when a user 50 is entering and/or exiting the site 30. Positioning facial recognition system 70 in such a manner may allow the system to generate an image of a user 50 whenever a user 50 enters or exits a site 30. Biometric information may then be extracted from the image and the entering and/or exiting user 50 may be identified.

In certain embodiments, facial recognition system 70 may integrate with various directories and/or other presence information to provide enhanced presence identification. As an example, facial recognition system 70 may interface with an enterprise directory which stores various images containing biometric information of enterprise users. The enterprise directory may contain front and non-frontal images of a user as well as images of users in various lighting conditions such as outdoor and indoor images. Maintaining a variety of images may provide enhanced identification capabilities. In a further embodiment, facial recognition system 70 may also integrate with other available presence information such as login or access information which may be required for one or more users 50 to join a conference session. Combining the identification capabilities of facial recognition system 70 with login information may facilitate presence detection by confirming that an identified user 50 actually joined or exited a conference. According to another embodiment, facial recognition system 70 may interface with scheduling software and attempt to identify the presence of a user 50 that is scheduled to attend the conference. Again, combining the capabilities of facial recognition system 70 with the scheduling software may ensure accurate identification.

According to another embodiment, facial recognition system 70 may be used to identify necessary conference participants. For example, when a conference organizer schedules a conference, the organizer may indicate that certain users 50, or a specified number of users 50, are necessary for a quorum. As users 50 join the conference, facial recognition system 70 may monitor the arrival of users 50 and indicate or announce when a quorum is present. In certain embodiments, the ability to commence a conference session may only be granted upon establishing a desired quorum of conference participants. Alternatively or additionally, a conference organizer may request to be notified when a particular user 50 joins the conference. In such circumstances, facial recognition system 70 may send a notice or other alert to the conference organizer when the particular user joins the conference. Facial recognition system 70 may thus be useful if certain conference attendees join a conference by entering a conference site rather than logging into the conference.

Modifications, additions, or omissions may be made to communication system 10 and the components illustrated therein. For example, as mentioned, the functionality associated with facial recognition system 70 may be disaggregated among various components of a site 30. Thus, the operations of facial recognition system 70 may be performed by more, fewer, or other components. Additionally, facial recognition 70 may be positioned in any suitable manner within a site 30 which may enable a camera associated with the system to generate an image of a user 50. As another example, communication system 10 may include any suitable number of sites 30 and may facilitate a conferencing between any suitable number of sites 30.

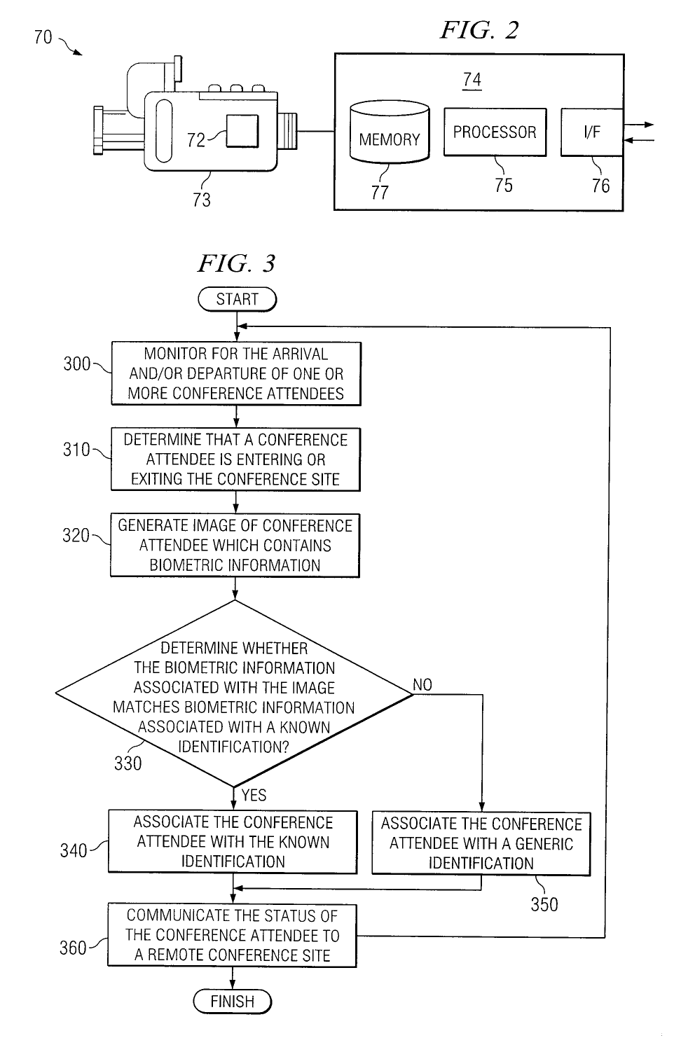

FIG. 2 is a simplified block diagram illustrating an embodiment of a facial recognition system 70. In the illustrated embodiment, facial recognition system 70 includes a sensor 72, digital camera 73, and control unit 74 which includes interface 76, memory 77, and processor 78.

Sensor 72 may be any device operable to determine that a participant is entering or exiting a conference site 30. For example, sensor 72 may be a motion detector, infrared or acoustic device, and/or radio frequency identification (RFID) tag. In response to determining that an attendee is entering or leaving a conference site, sensor 72 may signal digital camera 73 to generate an image associated with the attendee. While sensor 72 is illustrated as integral with digital camera 73, it may communicatively couple to camera 73 remotely.

Digital camera 73 and controller 74 may operatively couple to determine the identity of a user 50 based on associated biometric information. Digital camera 73 is a device which may capture an image of a user 50 from which biometric information may be extracted or analyzed. Digital camera 73 may be substantially similar to previously described video camera 42. In operation, digital camera 73 may generate a high resolution image of the face and/or retina of a user 50 in response to sensor 72 indicating that a conference attendee is entering or exiting a conference site. Digital camera 73 may then transmit a digital representation of the image to controller 74 for further processing. Controller 74 represents software and hardware which is operable to receive an image generated by digital camera 73 and match biometric information associated with the image to an identity associated with a user 50.

Interface 76 represents any port or connection, real or virtual, which may communicatively connect facial recognition system 70 with another device. In general, interface 76 may include any appropriate combination of software and/or hardware to support communication between facial recognition system 70 and components of communication network 20 or a site 30. For instance, interface 76 may couple facial recognition system 70 to an enterprise directory , enterprise network, or various devices associated with conference equipment 40. In particular embodiments, interface 76 may include a Network Interface Card (NIC), and any appropriate controlling logic.

Memory 77 may store information used by control unit 74 and/or digital camera 73. Memory 77 may include any collection and arrangement of volatile or non-volatile, local or remote devices suitable for storing data. Examples of memory 77 include, but are not limited to, random access memory (RAM) devices, dynamic random access memory (DRAM), read only memory (ROM) devices, magnetic storage devices, optical storage devices, flash memory, or any other suitable data storage devices. In certain embodiments, memory 77 may store biometric information associated with one or more users 50. The stored biometric information may be used to match extracted biometric information from an image of a user 50 to a known identity. Memory 77 may also store algorithms or other software which may be used to provide the recognition and identification of facial recognition system 70. In addition, memory 77 may store software for execution by processor 78 to control operation and perform the described functionality of facial recognition system 70.

Processor 78 controls the operation of facial recognition system 70. In particular, processor 78 may match image based biometric information generated by camera 73 to a known identity. Processor 78 may execute code to perform any of the described operations and may represent any suitable device(s) capable of processing and/or communicating electronic information. Examples of processor 78 include, but are not limited to, application-specific integrated circuits (ASICs), field-proggrammable gate arrays (FGPAs), digital signal processors (DSPs), and any other suitable specific or general purpose processors.

While the illustrated embodiment contains a particular number and configuration of components, facial recognition system 70 may include any components which operable to provide the recited functionality. As an example, in certain embodiments, sensor 72, digital camera 73, and control unit 74 may be combined into a single device. Additionally, certain embodiments of facial recognition system 70 may not include a sensor 72. In such embodiments, digital camera 73 may, for example, continuously generate images containing biometric information associated with conference attendees. Further, facial recognition system 70 may include any number of digital cameras 72. Accordingly, facial recognition system 70 may include more, fewer, or other components.

Referring now to FIG. 3, a method for detecting the presence of a conference attendee is provided. In the described embodiment, a facial recognition system 70 may determine that a conference attendee has entered and/or exited a conference site and announce the arrival or departure to a participant at a remote conference site.

The described method begins at step 300 where facial recognition system 70 monitors for the arrival and/or departure of one or more conference attendees. At step 310, facial recognition system 70 may determine that a conference attendee is entering or exiting the conference site. This determination may be made by sensor 72 or other device suitable for detecting the arrival and/or departure of an attendee. In response to determining that a conference attendee is entering or exiting the conference site, digital camera 73 of facial recognition system 70 may generate an image associated with the attendee which contains suitable biometric information at step 320. As mentioned, biometric information may be any physical trait or characteristic which is unique to the attendee. Appropriate biometric information may include facial or retinal patterns.

At step 330, facial recognition system 70 may determine whether the biometric information associated with the image matches biometric information associated with a known identification. This determination may be made using any suitable pattern matching or recognition algorithm. If the biometric information contained in the image is associated with a known identification, facial recognition system 70 may, at step 340, associate the attendee with the identification. Alternatively, if the biometric information associated with the image does not match biometric information having a known identification, then facial recognition system may associate the attendee with a generic identification at step 350. As an example, the generic identification may be a label such as “user 1,” “Unknown attendee,” etc. Once an identification (either known or generic) has been associated with the attendee, facial recognition system 70 may communicate the status of the conference attendee to a remote conference site at step 350. In certain embodiments, step 360 may involve sending a notification to one or more remote sites 30 that are participating in the conference. The notification may indicate whether the conference attendee is present.

After sending the notification, the described process may return to step 300 where facial recognition system 70 may proceed to monitor the arrival and/or departure of one or more conference attendees. Alternatively, if the conference session has ended or terminated, then facial recognition system may conclude. Although a particular process has been described, modifications, additions, or omissions may be made to the method depicted in FIG. 3. In certain embodiments, the method may include more, fewer, or other steps. Additionally, steps may be performed in any suitable order without departing from the scope of the disclosure.

While certain embodiments have been described in detail numerous changes, substitutions, variations, alterations and modifications may be ascertained by those skilled in the art, and it is intended that the present disclosure encompass all such changes, substitutions, variations, alterations and modifications as falling within the spirit and scope of the appended claims.

What is claimed is:

1. A method comprising:
receiving an image of a conference attendee, the image comprising biometric information associated with the conference attendee;
extracting the biometric information associated with the conference attendee from the image;
determining a status of the conference attendee; and
communicating the status of the conference attendee in response to determining the status of the conference attendee.

2. The method of claim 1, further comprising:
determining whether the extracted biometric information matches biometric information associated with a known identification;
associating the conference attendee with the known identification in response to determining that the extracted biometric information matches biometric information associated with a known identification.

3. The method of claim 2, further comprising associating the conference attendee with a generic identification in response to determining that the extracted biometric information does not match biometric information associated with a known identification.

4. The method of claim 2, wherein determining whether the extracted biometric information matches biometric information associated with a known identification comprises comparing the extracted biometric information to biometric information associated with a conference attendee scheduled to attend the conference.

5. The method of claim 2, wherein determining whether the extracted biometric information matches biometric information associated with a known identification comprises comparing the extracted biometric information to biometric information stored in an enterprise directory, wherein the biometric information stored in the enterprise directory is associated with one or more enterprise users.

6. The method of claim 1, wherein receiving an image of a conference attendee occurs in response to determining that a conference attendee is exiting a conference site.

7. The method of claim 1, wherein receiving an image of a conference attendee occurs in response to determining that a conference attendee is entering a conference site.

8. The method of claim 1, further comprising determining that one or more necessary conference participants are present, wherein necessary conference participants include one or more conference attendees indicated as necessary.

9. An apparatus comprising a processor operable to:
receive an image of a conference attendee, the image comprising biometric information associated with the conference attendee; and
extract the biometric information associated with the conference attendee from the image;
determine a status of the conference attendee; and
communicate the status of the conference attendee in response to determining the status of the conference attendee.

10. The apparatus of claim 9, wherein the processor is further operable to:
determine whether the extracted biometric information matches biometric information associated with a known identification;
associate the conference attendee with the known identification in response to determining that the extracted biometric information matches biometric information associated with a known identification.

11. The apparatus of claim 10, wherein the processor is further operable to associate the conference attendee with a generic identification in response to determining that the extracted biometric information does not match biometric information associated with a known identification.

12. The apparatus of claim 10, wherein a processor operable to determine whether the extracted biometric information matches biometric information associated with a known identification comprises a processor operable to compare the extracted biometric information to biometric information associated with a conference attendee scheduled to attend the conference.

13. The apparatus of claim 10, wherein a processor operable to determine whether the extracted biometric information matches biometric information associated with a known identification comprises a processor operable to compare the extracted biometric information to biometric information stored in an enterprise directory, wherein the biometric information stored in the enterprise directory is associated with one or more enterprise users.

14. The apparatus of claim 9, wherein a processor operable to receive an image of a conference attendee comprises a processor operable to receive an image of a conference attendee in response to determining that a conference attendee is exiting a conference site.

15. The apparatus of claim 9, wherein a processor operable to receive an image of a conference attendee comprises a processor operable to receive an image of a conference attendee in response to determining that a conference attendee is entering a conference site.

16. The apparatus of claim 9, wherein the processor is further operable to determine that one or more necessary conference participants are present, wherein necessary conference participants include one or more conference attendees indicated as necessary.

17. Logic encoded in one or more tangible media for execution and when executed operable to:
receive an image of a conference attendee, the image comprising biometric information associated with the conference attendee; and
extract the biometric information associated with the conference attendee from the image;
determine a status of the conference attendee; and
communicate the status of the conference attendee in response to determining the status of the conference attendee.

18. The logic of claim 17, wherein the logic is further operable to:
determine whether the extracted biometric information matches biometric information associated with a known identification;
associate the conference attendee with the known identification in response to determining that the extracted biometric information matches biometric information associated with a known identification.

19. The logic of claim 18, wherein the logic is further operable to associate the conference attendee with a generic identification in response to determining that the extracted biometric information does not match biometric information associated with a known identification.

20. The logic of claim 18, wherein logic to determine whether the extracted biometric information matches biometric information associated with a known identification comprises logic operable to compare the extracted biometric information to biometric information stored in an enterprise directory, wherein the biometric information stored in the enterprise directory is associated with one or more enterprise users.

21. The logic of claim 18, wherein logic operable to determine whether the extracted biometric information matches biometric information associated with a known identification comprises logic operable to compare the extracted biometric information to biometric information associated with a conference attendee scheduled to attend the conference.

22. The logic of claim 17, wherein logic operable to receive an image of a conference attendee comprises logic operable to receive an image of a conference attendee in response to determining that a conference attendee is exiting a conference site.

23. The logic of claim 17, wherein logic operable to receive an image of a conference attendee comprises logic operable to receive an image of a conference attendee in response to determining that a conference attendee is entering a conference site.

24. The logic of claim 17, wherein the logic is further operable to determine that one or more necessary conference participants are present, wherein necessary conference participants include one or more conference attendees indicated as necessary.

25. A system comprising:
means for receiving an image of a conference attendee, the image comprising biometric information associated with the conference attendee;
means for extracting the biometric information associated with the conference attendee from the image;
means for determining a status of the conference attendee; and
means for communicating the status of the conference attendee in response to determining the status of the conference attendee.
